(19) United States
(12) Patent Application Publication
(10) Pub. No.: US 2017/0058871 A1
(43) Pub. Date: Mar. 2, 2017

(54) SYSTEM AND METHOD FOR MITIGATING ICE THROW FROM A WIND TURBINE ROTOR BLADE

(71) Applicant: General Electric Company, Schenectady, NY (US)

(72) Inventors: Bernardo Adrian Movsichoff, Simpsonville, SC (US); Ejaz J. Sabir, Simpsonville, SC (US); Karthikeyan Appuraj, Hyderabad (IN); Kunal Vora, Verona, WI (US); Joerg Middendorf, Niedersachsen (DE); Gert Torbohm, Rheine (DE)

(21) Appl. No.: 14/837,130

(22) Filed: Aug. 27, 2015

(51) Int. Cl. F03D 80/40; F03D 7/02

(52) U.S. Cl. CPC F03D 80/40; F03D 7/0224

(57) ABSTRACT

The present disclosure is directed to a system and method for mitigating ice throw from one or more rotor blades of a wind turbine during operation. The method includes monitoring one or more ice-related parameters of the wind turbine. Thus, the ice-related parameters are indicative of ice accumulation on one or more of the rotor blades. In response to detecting ice accumulation, the method also includes implementing an ice protection control strategy. More specifically, the ice protection control strategy includes determining a yaw position of the wind turbine and determining at least one of a power set point or a speed set point for the wind turbine based on the yaw position.

### FIELD OF THE INVENTION

The present subject matter relates generally to wind turbines and, more particularly, to a system and method for mitigating ice throw from a wind turbine rotor blade.

### BACKGROUND OF THE INVENTION

Generally, a wind turbine includes a tower, a nacelle mounted on the tower, and a rotor coupled to the nacelle. The rotor typically includes a rotatable hub and a plurality of rotor blades coupled to and extending outwardly from the hub. Each rotor blade may be spaced about the hub so as to facilitate rotating the rotor to enable kinetic energy to be transferred from the wind into usable mechanical energy, and subsequently, electrical energy.

Under some atmospheric conditions, ice may be buildup or otherwise accumulate on the rotor blades of a wind turbine. As the ice layer accumulating on a rotor blade becomes increasingly thicker, the aerodynamic surface of the blade is modified, thereby resulting in diminished aerodynamic performance. Moreover, ice accumulation significantly increases the weight of a rotor blade, which can lead to structural damage as an increased amount of bending moments and/or other rotational forces act on the rotor blade. Further, when there is a difference in the amount of ice accumulating on each of the rotor blades, a mass imbalance may occur that can cause significant damage to a wind turbine.

In addition, ice accumulation may be shed or throw from the turbine due to both gravity and/or mechanical forces of the rotating blades. For example, an increase in ambient temperature, wind, and/or solar radiation may cause sheets or fragments of ice to loosen and fall, making the area directly under the rotor subject to the greatest risks. Further, rotating turbine blades may throw or propel ice fragments some distance from the turbine, e.g. up to several hundred meters if conditions are right. Falling ice may cause damage to neighboring structures and/or vehicles, as well as injury to site personnel and/or the general public, unless adequate measures are put in place for protection.

Due to the disadvantages associated with ice accumulation, a wind turbine may be shutdown when it is believed that ice has accumulated on the surface of one or more of the rotor blades. Operation of the wind turbine may then be restarted after it can be verified that ice is no longer present on the rotor blades. Accordingly, upon shutdown of a wind turbine for ice accumulation, each rotor blade is typically inspected to determine whether ice is actually and/or is still present on the blades. Shutting down the wind turbine, however, is not desirable as this impacts power production.

Accordingly, a system and method that mitigates ice throw from the rotor blades of the wind turbine so as to address the aforementioned issues would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a method for mitigating ice throw from one or more rotor blades of a wind turbine during operation. The method includes determining one or more ice-related parameters of the wind turbine. Thus, the ice-related parameters are indicative of ice accumulation on one or more of the rotor blades. In response to detecting ice accumulation, the method also includes implementing an ice protection control strategy. More specifically, the ice protection control strategy includes determining a yaw position of the wind turbine and determining at least one of a power set point or a speed set point for the wind turbine based on the yaw position.

In one embodiment, the step of determining at least one of the power set point or the speed set point for the wind turbine based on the yaw position may further include: determining at least one sector for the yaw position, determining if the sector corresponds to one or more predetermined risk sectors, and reducing at least one of the power set point or the speed set point of the wind turbine if the sector corresponds to one of the predetermined risk sectors. In another embodiment, the method may also include maintaining the power set point and the speed set point of the wind turbine, reducing at least one of the power set point or the speed set point of the wind turbine, or increasing the power set point and the speed set point of the wind turbine so as to maximize power production.

In certain embodiments, the step of determining one or more ice-related parameters of the wind turbine may include monitoring one or more ice-related parameters via one or more sensors. More specifically, the one or more sensors may include at least one of accelerometers, internal icing sensors, external icing sensors, vibration sensors, or similar. Alternatively, the step of determining one or more ice-related parameters of the wind turbine may further include calculating one or more ice-related parameters via at least one control algorithm.

In additional embodiments, the ice-related parameters of the wind turbine may include any one of or a combination of ambient conditions, a date, a time, a pitch angle of the one or more rotor blades, a tip-speed-ratio (TSR), a power output, a stall line, torque, thrust, a power coefficient, or similar. For example, in certain embodiments, the ambient conditions near the wind turbine may include one or more of an ambient temperature, a component temperature, pressure, air density, wind speed, humidity, or similar.

In further embodiments, the method may also include starting the ice protection control strategy when the ambient temperature is below a predetermined temperature set point and stopping the ice protection control strategy when the ambient temperature is above the predetermined temperature set point, e.g. for a predetermined time period.

In yet another embodiment, the method may also include initially operating the wind turbine at an initial speed set point that corresponds to an optimal tip-speed-ratio value, an optimal pitch angle curve versus tip-speed-ratio (TSR), and an optimal stall margin. Thus, in response to detecting ice accumulation, the method may include replacing the optimal pitch angle curve versus TSR with an equivalent pitch angle curve representing the iced rotor blade. In addition, the method may also include updating the optimal stall margin based on the equivalent pitch angle curve.

In further embodiments, the method may include initially operating the wind turbine at an initial speed set point with a corresponding minimum pitch setting and, in response to detecting ice accumulation, providing a pitch offset to the minimum pitch setting. In yet another embodiment, the method may include initially operating the wind turbine at a torque-speed curve and, in response to detecting ice accumulation, modifying a torque constant of the torque-speed curve.

In a further embodiment, the method may also include manually implementing the ice protection control strategy via a network. Alternatively, the method may include automatically implementing the ice protection control strategy.

In another aspect, the present disclosure is directed to a method for mitigating ice throw from one or more rotor blades of a wind turbine. The method includes operating the wind turbine at an initial speed set point that corresponds to an optimal tip-speed-ratio value, an optimal pitch angle versus tip-speed-ratio (TSR) curve, and an optimal stall margin. In response to detecting ice accumulation on the rotor blade, the method also includes implementing an ice protection control strategy. More specifically, the ice protection control strategy includes determining a yaw position of a rotor of the wind turbine, determining an updated speed set point for the wind turbine based on the yaw position, replacing the optimal pitch angle versus TSR curve with an equivalent pitch angle curve representing the iced rotor blade, and updating the optimal stall margin based on the equivalent pitch angle curve.

In yet another aspect, the present disclosure is directed to a system for mitigating ice throw from one or more rotor blades of a wind turbine. The system includes one or more sensors configured to monitor one or more ice-related parameters of the wind turbine and a controller communicatively coupled to the one or more sensors. The ice-related parameters are indicative of ice accumulation on one or more rotor blades of the wind turbine. Thus, the controller is configured to perform one or more operations, including but not limited to implementing an ice protection control strategy in response to detecting ice accumulation. More specifically, the ice protection strategy includes determining a yaw position of the wind turbine and determining at least one of a power set point or a speed set point for the wind turbine based on the yaw position. It should be understood that the system may be further configured to include any of the additional features and/or to implement any of the method steps as described herein.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a wind turbine according to the present disclosure;

FIG. 2 illustrates a simplified, internal view of one embodiment of a nacelle of a wind turbine according to the present disclosure;

FIG. 3 illustrates a schematic diagram of one embodiment of suitable components that may be included within a turbine controller of a wind turbine according to the present disclosure;

FIG. 4 illustrates a flow diagram of one embodiment of a method for mitigating ice throw from one or more rotor blades of a wind turbine according to the present disclosure; and

FIG. 5 illustrates a schematic diagram of one embodiment of a yaw position of a rotor of a wind turbine corresponding to one or more sectors according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, the present disclosure is directed to a system and method for mitigating ice throw from a rotor blade of a wind turbine during operation. Specifically, the present disclosure provides a controller configured to implement an ice protection control strategy or algorithm that measures ambient conditions and the yaw position of the turbine. The algorithm also creates sectors during which the rotor speed and/or the power output of the turbine can be reduced if, under icing conditions, the rotor speed needs to be reduced (i.e. ice accumulation is present and the yaw position poses a risk or danger to neighboring areas). For example, the sectors may be configured such that a band of impacted operation regions are created. Accordingly, if the yaw position falls within one or more impacted sectors under icing conditions (and/or during specific days and/or hours), the rotor speed and/or power output can be reduced to eliminate the possibility of ice throw in a certain direction.

The present disclosure may be implemented locally on a turbine controller, or, as an alternative, on a remote system, e.g. a farm level controller or a dedicated remote computer. In such an embodiment, the ice protection control strategy may reside remotely and/or sensors may be mounted locally on the wind turbine. Thus, the sensors and/or the remote controller can be connected through a network.

The present disclosure provides many advantages not present in the prior art. For example, the present disclosure addresses safety concerns for neighboring people and/or property of the wind turbine and minimizes turbine output reduction. Thus, the ice protection control strategy of the present disclosure permits extended operation of the turbine thereby avoiding unavailability and lost production under icing conditions.

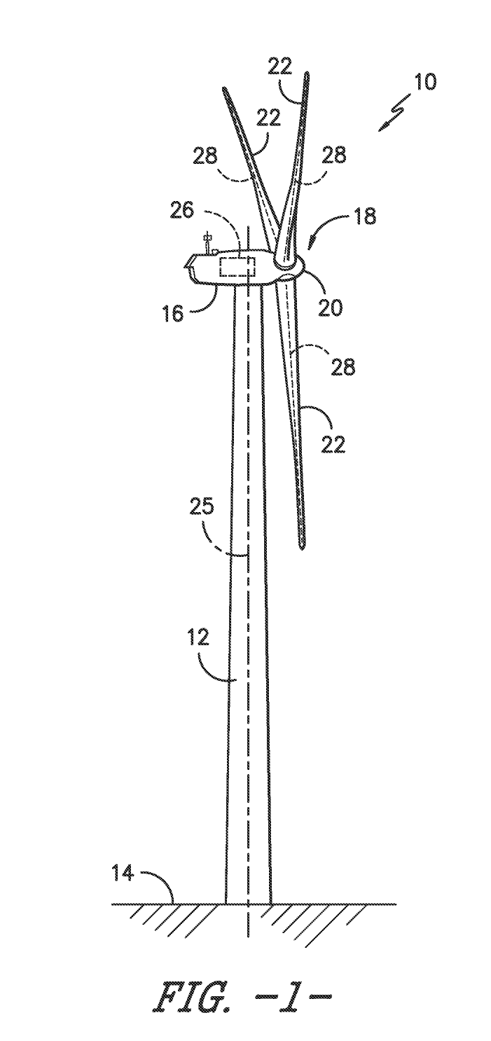

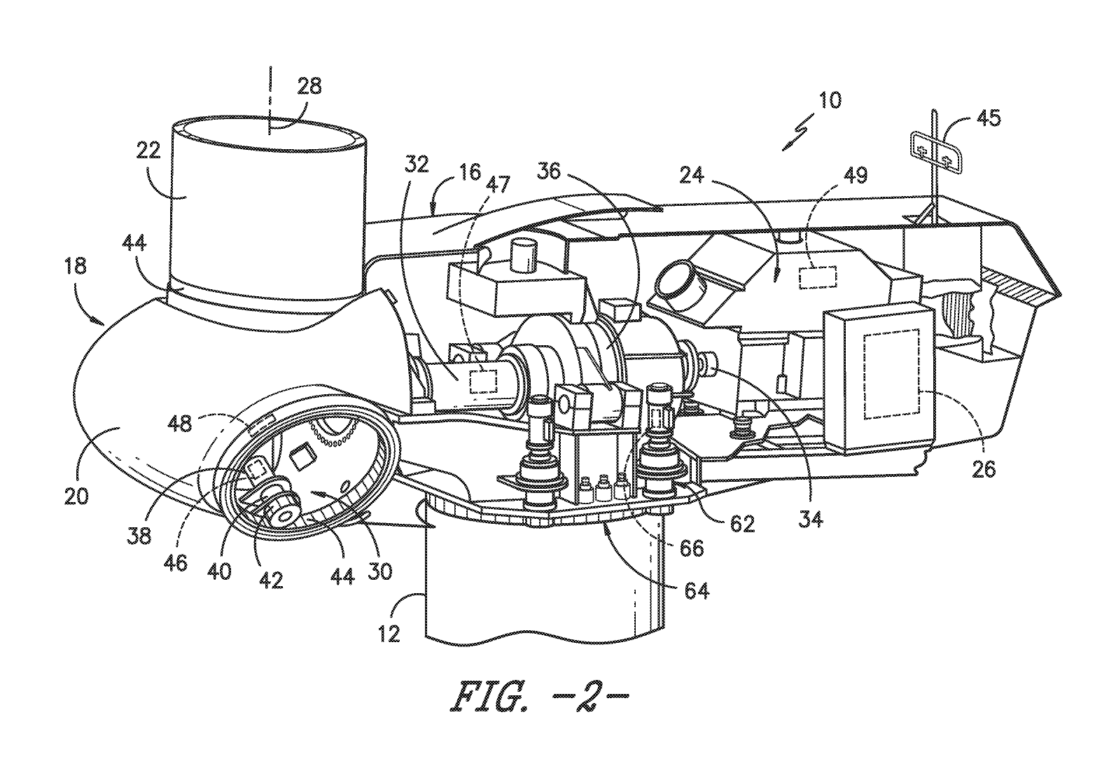

Referring now to the drawings, FIG. 1 illustrates a perspective view of one embodiment of a wind turbine 10. As shown, the wind turbine 10 generally includes a tower 12 extending from a support surface 14, a nacelle 16 mounted on the tower 12, and a rotor 18 coupled to the nacelle 16. The rotor 18 includes a rotatable hub 20 and at least one rotor blade 22 coupled to and extending outwardly from the hub 20. For example, in the illustrated embodiment, the rotor 18 includes three rotor blades 22. However, in an alternative embodiment, the rotor 18 may include more or less than three rotor blades 22. Each rotor blade 22 may be spaced about the hub 20 to facilitate rotating the rotor 18 to enable kinetic energy to be transferred from the wind into usable mechanical energy, and subsequently, electrical energy. For instance, the hub 20 may be rotatably coupled to an electric generator 24 (FIG. 2) positioned within the nacelle 16 to permit electrical energy to be produced.

The wind turbine 10 may also include a turbine control system or turbine controller 26 centralized within the nacelle 16. In addition, the turbine controller 26 may be connected to a farm level controller (not shown) via a network. In general, the turbine controller 26 (and/or the farm controller) may include a computer or other suitable processing unit. Thus, in several embodiments, the controller 26 may include suitable computer-readable instructions that, when implemented, configure the controller 26 to perform various different functions, such as receiving, transmitting and/or executing wind turbine control signals. As such, the turbine controller 26 may generally be configured to control the various operating modes (e.g., start-up or shut-down sequences) and/or components of the wind turbine 10. For example, the controller 26 may be configured to adjust the blade pitch or pitch angle of each rotor blade 22 (i.e., an angle that determines a perspective of the blade 22 with respect to the direction of the wind) about its pitch axis 28 in order to control the rotational speed of the rotor blade 22 and/or the power output generated by the wind turbine 10. For instance, the turbine controller 26 may control the pitch angle of the rotor blades 22, either individually or simultaneously, by transmitting suitable control signals to one or more pitch drives or pitch adjustment mechanisms 30 (FIG. 2) of the wind turbine 10. During operation of the wind turbine 10, the controller 26 may generally control each pitch adjustment mechanism 30 in order to alter the pitch angle of each rotor blade 22 between 0 degrees (i.e., a power position of the rotor blade 22) and 90 degrees (i.e., a feathered position of the rotor blade 22). In addition, the controller 26 may generally control one or more yaw drive mechanisms 62 that are configured to orient the nacelle 16 with respect to the wind.

Referring now to FIG. 2, a simplified, internal view of one embodiment of the nacelle 16 of the wind turbine 10 shown in FIG. 1 is illustrated. As shown, the generator 24 may be disposed within the nacelle 16. In general, the generator 24 may be coupled to the rotor 18 for producing electrical power from the rotational energy generated by the rotor 18. For example, as shown in the illustrated embodiment, the rotor 18 may include a rotor shaft 32 coupled to the hub 20 for rotation therewith. The rotor shaft 32 may, in turn, be rotatably coupled to a generator shaft 34 of the generator 24 through a gearbox 36. As is generally understood, the rotor shaft 32 may provide a low speed, high torque input to the gearbox 36 in response to rotation of the rotor blades 22 and the hub 20. The gearbox 36 may then be configured to convert the low speed, high torque input to a high speed, low torque output to drive the generator shaft 34 and, thus, the generator 24.

Additionally, the turbine controller 26 may also be located within the nacelle 16. As is generally understood, the turbine controller 26 may be communicatively coupled to any number of the components of the wind turbine 10 in order to control operation of such components. For example, as indicated above, the turbine controller 26 may be communicatively coupled to each pitch adjustment mechanism 30 of the wind turbine 10 (one of which is shown) to facilitate rotation of each rotor blade 22 about its pitch axis 28. Similarly, the turbine controller 26 may be communicatively coupled to each yaw drive mechanism 62 of the wind turbine 10 to facilitate rotation of the nacelle 16 about its yaw axis 25 (FIG. 1).

In general, each pitch adjustment mechanism 30 may include any suitable components and may have any suitable configuration that allows the pitch adjustment mechanism 30 to function as described herein. For example, in several embodiments, each pitch adjustment mechanism 30 may include a pitch drive motor 38 (e.g., any suitable electric motor), a pitch drive gearbox 40, and a pitch drive pinion 42. In such embodiments, the pitch drive motor 38 may be coupled to the pitch drive gearbox 40 so that the pitch drive motor 38 imparts mechanical force to the pitch drive gearbox 40. Similarly, the pitch drive gearbox 40 may be coupled to the pitch drive pinion 42 for rotation therewith. The pitch drive pinion 42 may, in turn, be in rotational engagement with a pitch bearing 44 coupled between the hub 20 and a corresponding rotor blade 22 such that rotation of the pitch drive pinion 42 causes rotation of the pitch bearing 44. Thus, in such embodiments, rotation of the pitch drive motor 38 drives the pitch drive gearbox 40 and the pitch drive pinion 42, thereby rotating the pitch bearing 44 and the rotor blade 22 about the pitch axis 28.

In alternative embodiments, it should be appreciated that each pitch adjustment mechanism 30 may have any other suitable configuration that facilitates rotation of a rotor blade 22 about its pitch axis 28. For instance, pitch adjustment mechanisms are known that include a hydraulic or pneumatic driven device (e.g., a hydraulic or pneumatic cylinder) configured to transmit rotational energy to the pitch bearing 44, thereby causing the rotor blade 22 to rotate about its pitch axis 28. Thus, in several embodiments, instead of the electric pitch drive motor 38 described above, each pitch adjustment mechanism 30 may include a hydraulic or pneumatic driven device that utilizes fluid pressure to apply torque to the pitch bearing 44.

In additional embodiments, as mentioned, the wind turbine 10 may also include one or more yaw drive mechanisms 62 configured to rotate the nacelle 16 relative to the wind, e.g. about yaw axis 25. For example, the wind turbine 10 may include a yaw bearing 64 configured between the tower 12 and the nacelle 16 that is operatively coupled to one or more yaw drive mechanisms 62. Thus, the yaw drive mechanisms 62 are configured to rotate the yaw bearing 64 so as to rotate the nacelle 16 about the yaw axis 25.

Referring still to FIG. 2, the wind turbine 10 may also include a plurality of sensors 45, 46, 47, 48, 49 for monitoring one or more parameters and/or conditions of the wind turbine 10. As used herein, a parameter or condition of the wind turbine 10 is “monitored” when a sensor 45, 46, 47, 48, 49 is used to determine its present value. Thus, the term “monitor” and variations thereof are used to indicate that the sensors 45, 46, 47, 48, 49 need not provide a direct measurement of the parameter and/or condition being monitored. For example, the sensors 45, 46, 47, 48, 49 may be used to generate signals relating to the parameter and/or condition being monitored, which can then be utilized by the turbine controller 26 or other suitable device to determine the actual parameter and/or condition.

Thus, in several embodiments of the present disclosure, the wind turbine 10 may include one or more sensors 45, 46, 47, 48, 49 configured to monitor one or more ice-related parameters of the wind turbine 10. Specifically, in several embodiments, the wind turbine 10 may include one or more sensors 46 configured to transmit signals to the turbine controller 26 relating directly to the amount of torque generated by each pitch adjustment mechanism 30. For example, the sensor(s) 46 may include one or more torque sensors coupled to a portion of the pitch drive motor 38, the pitch gearbox 40, and/or the pitch drive pinion 42 in order to monitor the torque generated by each pitch adjustment mechanism 30. Alternatively, the sensor(s) 46 may include one or more suitable sensors configured to transmit signals to the turbine controller 26 relating indirectly to the amount of torque generated by each pitch adjustment mechanism 30. For instance, in embodiments in which the pitch drive mechanism 30 is electrically driven, the sensor(s) 46 may include one or more current sensors configured to detect the electrical current supplied to the pitch drive motor 38 of each pitch adjustment mechanism 30. Similarly, in embodiments in which the pitch adjustment mechanism 30 is hydraulically or pneumatically driven, the sensor(s) 46 may include one or more suitable pressure sensors configured to detect the pressure of the fluid within the hydraulically or pneumatically driven device. In such embodiments, the turbine controller 26 may generally include suitable computer-readable instructions (e.g., in the form of suitable equations, transfer functions, models and/or the like) that, when implemented, configure the controller 26 to correlate the current input or the pressure input to the torque generated by each pitch adjustment mechanism 30.

In addition to the sensor(s) 46 described above or as an alternative thereto, the wind turbine 10 may also include one or more sensors 48 configured to monitor the torque required to pitch each rotor blade 22 by monitoring the force(s) present at the pitch bearing 44 (e.g., the force(s) present at the interface between the pitch drive pinion 42 and the pitch bearing 44). For example, the sensor(s) 48 may include one or more pressure sensors and/or any other suitable sensors configured to transmit signals relating to the forces present at the pitch bearing 44. In such an embodiment, similar to that described above, the turbine controller 26 may generally include suitable computer-readable instructions (e.g., in the form of suitable equations, transfer functions, models and the like) that, when implemented, configure the controller 26 to correlate the force(s) present at the pitch bearing 44 to the torque required to pitch each rotor blade 22.

It should be appreciated that the wind turbine 10 may also include various other sensors 45, 47, 49 for monitoring any other suitable parameters and/or conditions of the wind turbine 10. For example, the wind turbine 10 may include sensors for monitoring the pitch angle of each rotor blade 22, bending moments on the rotor blades 22, the speed of the rotor and/or the rotor shaft 32, the speed of the generator 24 and/or the generator shaft 34 (e.g. via sensor 49), the torque on the rotor shaft 32 (e.g. via sensor 47) and/or the generator shaft 34, the wind speed, wind direction or any other ambient conditions (e.g. via sensor 45) and/or any other suitable parameters and/or conditions.

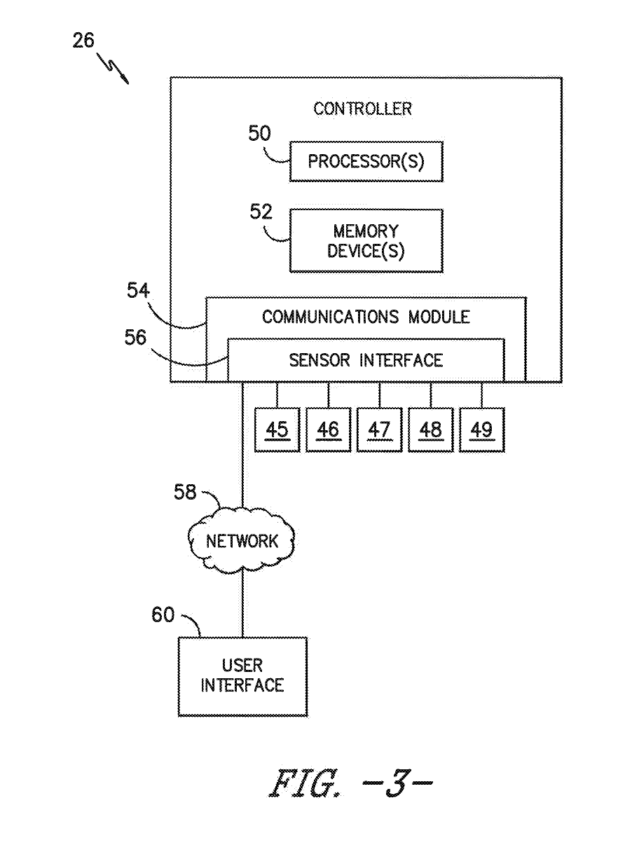

Referring now to FIG. 3, there is illustrated a block diagram of one embodiment of suitable components that may be included within the turbine controller 26 (and/or the farm controller) in accordance with aspects of the present subject matter. As shown, the controller 26 may include one or more processor(s) 50 and associated memory device(s) 52 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 52 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 52 may generally be configured to store suitable computer-readable instructions that, when implemented by the processor(s) 50, configure the turbine controller 26 to perform various functions including, but not limited to, transmitting suitable control signals to one or more of the pitch adjustment mechanisms 30, monitoring various parameters and/or conditions of the wind turbine 10 and various other suitable computer-implemented functions.

Additionally, the controller 26 may also include a communications module 54 to facilitate communications between the controller 26 and the various components of the wind turbine 10. For instance, the communications module 54 may serve as an interface to permit the controller 26 to transmit control signals to each pitch adjustment mechanism 30 for controlling the pitch angle of the rotor blades 22. Moreover, the communications module 54 may include a sensor interface 56 (e.g., one or more analog-to-digital converters) to permit signals transmitted from the sensors 45, 46, 47, 48, 49 of the wind turbine 10 to be converted into signals that can be understood and processed by the processors 50. In addition, as shown, the controller 26 may be communicatively coupled to a user interface 60 via a network 58 such that a user can implement certain functions to the controller 26, e.g. override one or more functions of the controller 26. For example, in certain embodiments, a user may override operational settings of the wind turbine 10 via the user interface so as to implement the ice protection control strategy as described herein. Alternatively, the controller 26 may be configured to automatically implement the ice protection control strategy as described herein. For example, the turbine controller 26 may be provided with suitable computer-readable instructions that, when implemented, configure the controller 26 to transmit control signals to various components of the wind turbine 10 in order to mitigate ice throw by one or more of the rotor blades 16. In addition, the controller 26 may be connected to the farm controller via the network 58 such that the farm controller can provide commands to the individual wind turbines.

It should be appreciated that the sensors 45, 46, 47, 48, 49 may be communicatively coupled to the communications module 54 using any suitable means. For example, as shown in FIG. 3, each sensor 45, 46, 47, 48, 49 is coupled to the sensor interface 56 via a wired connection. However, in other embodiments, the sensors 45, 46, 47, 48, 49 may be coupled to the sensor interface 56 via a wireless connection, such as by using any suitable wireless communications protocol known in the art.

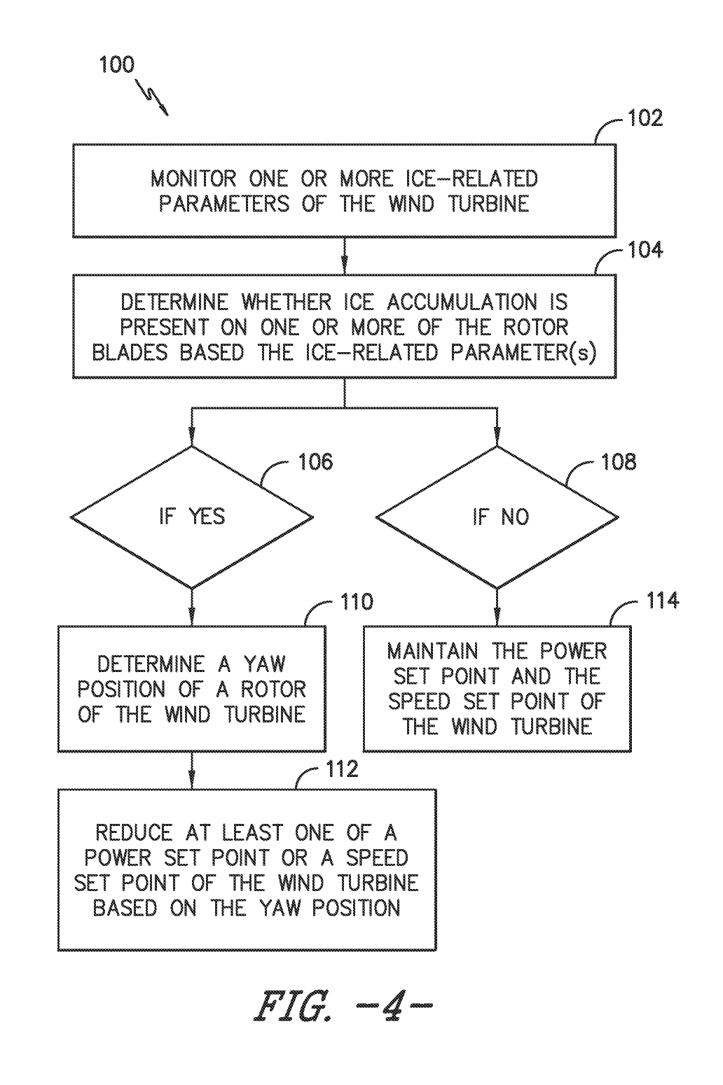

Referring now to FIG. 4, there is illustrated a flow diagram of one embodiment of a method 100 for mitigating ice throw from one or more rotor blades 16 of the wind turbine 10. For example, as shown at 102, the method 100 includes determining one or more ice-related parameters of the wind turbine 10. As used herein, the term “ice-related parameter” generally refers to any parameter and/or condition of the wind turbine 10 that may vary depending on whether ice is present on the blade 22. For example, in certain embodiments, the step of determining one or more ice-related parameters of the wind turbine may include monitoring one or more ice-related parameters via one or more sensors. More specifically, the one or more sensors may include at least one of accelerometers, internal icing sensors, external icing sensors, vibration sensors, or similar. As used herein, internal icing sensors generally encompass sensors associated with the wind turbine, whereas external icing sensors generally encompass sensors that are remote from the wind turbine. Alternatively, the step of determining one or more ice-related parameters of the wind turbine may further include calculating one or more ice-related parameters via at least one control algorithm.

In addition, the ice-related parameters of the wind turbine 10 may include any one of or a combination of ambient conditions, a day/time, a pitch angle of the one or more rotor blades, a tip-speed-ratio (TSR), a power output, a stall line, torque, thrust, a power coefficient, or similar, as well as additional parameters and/or conditions as described herein. More specifically, in certain embodiments, the ambient conditions may include one or more of an ambient temperature, a component temperature, pressure, humidity, wind speed, air density, or similar.

In certain embodiments, the ice-related parameter may correspond to the amount of torque required to pitch each rotor blade 22 across the range of pitch angles. Specifically, as indicated above, ice accumulation on a rotor blade 22 may increase the blade weight and may also alter its mass distribution. Thus, the torque required to pitch a rotor blade 22 having no ice accumulation may generally vary from the torque required to pitch the same rotor blade 22 having ice accumulated thereon.

For example, as indicated above, the torque required to pitch each rotor blade 22 may be monitored using one or more suitable sensors 45, 46, 47, 48, 49. For example, the torque generated by each pitch adjustment mechanism 30 may be monitored directly using suitable torque sensors or indirectly using various other suitable sensors (e.g., current sensors and/or pressure sensors configured monitor the current input and/or pressure input to the pitch adjustment mechanism 30). Alternatively, the torque required to pitch each rotor blade may be monitored by monitoring the force present at the pitch bearing 44 of the wind turbine 10.

In other embodiments, the ice-related parameter may correspond to the amount of time required to pitch each rotor blade 22, e.g. across the range of pitch angles. For example, in one embodiment, each pitch adjustment mechanism 30 may be configured to pitch each rotor blade 22 with a constant torque. As such, due to the increase in weight and/or the varied mass distribution caused by ice accumulation, the time required to pitch each rotor blade 22 may vary depending on the presence of ice. In such embodiments, the turbine controller 26 may generally be configured to monitor the time required to pitch each rotor blade 22. For example, the controller 26 may be provided with suitable computer readable instructions and/or suitable digital hardware (e.g., a digital counter) that configures the controller 26 to monitor the amount of time elapsed while each blade 22 is pitched across the range of pitch angles.

In even further embodiments, it should be appreciated that the ice-related parameter(s) may correspond to any other suitable parameter and/or condition of the wind turbine 10 that provides an indication of the presence of ice on a rotor blade 22. For example, the ice-related parameter may correspond to bending moments and/or other stresses acting on the rotor blade 22, as such bending moments and/or other stresses may generally vary due to the increased weight caused by ice accumulations. In such an embodiment, one or more strain gauges and/or other suitable sensors may be installed within the rotor blade 22 to permit such bending moments and/or other stresses to be monitored.

Referring still to FIG. 4, as shown at 104, the method 100 may also include determining whether ice accumulation is present on one or more of the rotor blades 16 based on the ice-related parameter(s). For instance, the controller 26 may be configured to compare the monitored ice-related parameter to a predetermined baseline profile for such parameter in order to determine whether ice is present on the rotor blade(s) 22. In general, the baseline profile may correspond to a predetermined set of reference values that are equal to the anticipated or actual values of the ice-related parameter being monitored assuming no ice is present on the rotor blade 22. For example, when the ice-related parameter corresponds to the amount of torque required to pitch each rotor blade 22, the baseline profile may include a predetermined set of values equal to the amount of torque required to pitch each rotor blade 22 across the range of pitch angles when no ice is present on the blade 22. Accordingly, variations from the baseline profile may generally provide an indication of ice accumulations on the rotor blade 22.

It should be appreciated that the baseline profile for a particular ice-related parameter may generally vary from wind turbine 10 to wind turbine 10 and/or from rotor blade 22 to rotor blade 22. Thus, in several embodiments, individual baseline profiles for the ice-related parameter being monitored may be determined for each rotor blade 22. In general, the baseline profiles for the rotor blades 22 may be determined using any suitable means and/or method known in the art. For instance, in one embodiment, the baseline profile of each rotor blade 22 may be determined experimentally, such as by individually pitching each rotor blade 22 when it is known that no ice is present on the blade 22 and monitoring the ice-related parameter of the blade 22 to establish the baseline profile. In another embodiment, the baseline profile for each rotor blade 22 may be modeled or determined mathematically, such as by calculating the baseline profiles based on, for example, the configuration of each rotor blade 22, the specifications of each pitch adjustment mechanism 30 and/or the anticipated variation in the ice-related parameter due to the presence of ice.

It should also be appreciated that, in several embodiments, the baseline profile established for a particular rotor blade 22 may be continuously updated. Specifically, due to wear and tear on wind turbine components and other factors, the baseline profile for a rotor blade 22 may vary over time. For example, wear and tear on one of the pitch bearings 44 may significantly affect the baseline profile for the corresponding rotor blade 22. Thus, in several embodiments, the turbine controller 26 may be configured to continuously adjust the baseline profile for each rotor blade 22 based on calculated and/or anticipated turbine component wear and/or on any other factors that may cause the baseline profile to vary over time.

Referring still to FIG. 4, as shown at 106, if ice accumulation is present, then the method 100 may further include implementing an ice protection control strategy that maximizes power production of the wind turbine 10. For example, as indicated above, wind turbines 10 are often shutdown when it is believed that ice is accumulating on one or more of the rotor blades 22 in order to prevent damage to the rotor blades 22 and/or to decrease the likelihood of damage/injury that may be caused by ice falling from the rotor blades 22. Moreover, when a wind turbine 10 is shut down due to the belief or actual presence of ice accumulations on one or more of the rotor blades 22, operation of the wind turbine 10 is not typically restarted until it has been verified that ice is no longer present on the blade(s) 22. Thus, the wind turbine 10 is unable to produce power until the turbine 10 is restarted. Accordingly, the disclosed method 100 allows for reduced operation of the turbine 10 rather than full shut down, thereby maximizing the power production of the wind turbine 10. More specifically, as shown at 110, the ice protection control strategy may include determining a yaw position of the rotor 18 of the wind turbine 10, e.g. via sensor 66. In addition, the ice protection control strategy may also include determining at least one of a power set point or a speed set point for the wind turbine based on the yaw position. For example, as shown at 112, the method 100 may include reducing the speed set point of the wind turbine 10 based on the yaw position. Alternatively, as shown at 108 and 114, if no ice accumulation is detected, the method 100 includes maintaining the power set point and the speed set point of the wind turbine 10 so as to maximize power production.

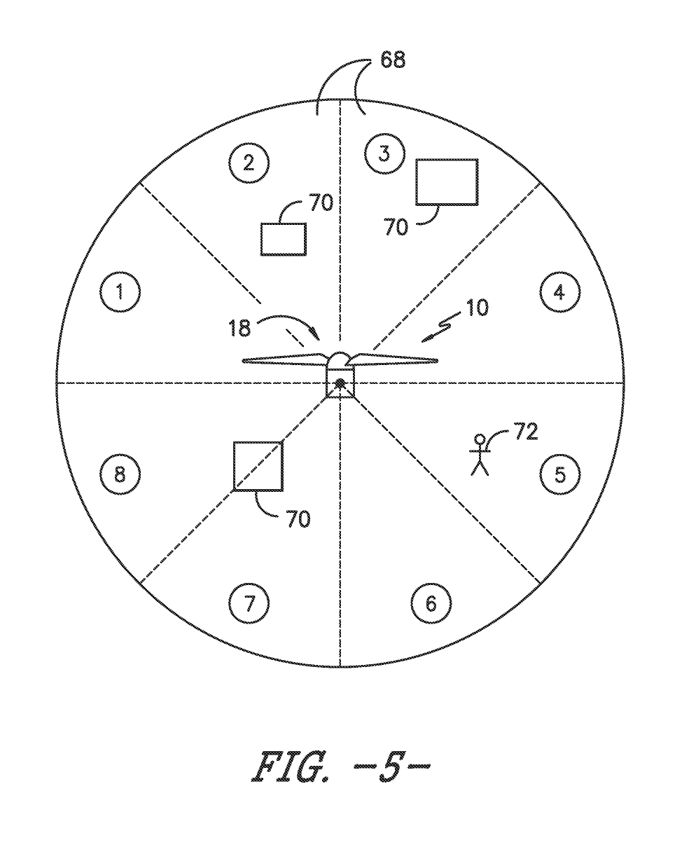

Referring now to FIG. 5, the controller 26 may also be configured to determine a sector 68 for the yaw position. More specifically, as shown, the yaw position of the rotor 18 may correspond to one or more sectors 68. Further, depending on various factors of the wind turbine 10, certain sectors may be deemed as predetermined risk sectors (e.g. due to the presence of people 72, structures 70, and/or vehicles in the sectors 68). As such, certain sectors 68 may be associated with a higher risk of ice throw. Thus, the controller 26 is configured to evaluate the risk associated with the rotor 18 being positioned in each sector. For example, as shown, the yaw position of the rotor 18 is associated with sections 1, 2, 3, and 4, which contain two structures 70. Based on the likelihood that the structures 70 may be damaged by ice throw, the controller 26 may control the power set point and/or the speed set point accordingly. More specifically, if ice accumulation is detected on one or more of the rotor blades 16 and the yaw position is associated with one of the predetermined risk sectors, then the controller 26 is configured to reduce either or both of the power or speed set point of the wind turbine 10 so as to mitigate ice throw while the rotor 18 remains in such a position. In a further embodiment, if the yaw position does not correspond to one or more predetermined risk sectors, then the controller 26 is configured to maintain the speed set point of the wind turbine 10.

During operation, the wind turbine 10 may be initially operated at an initial speed set point that corresponds, e.g. to an optimal tip-speed-ratio value, an optimal pitch angle curve, a minimum pitch setting, a torque-speed curve, and/or an optimal stall margin. When there is ice accumulation, the aerodynamic characteristics of the blade 16 may change. In particular, the stall line (minimum pitch vs. TSR) may change, the optimal pitch (vs. TSR) may change, and the thrust, torque, and power coefficient surfaces, as well as their partial derivative surfaces, may change. Thus, in certain embodiments, in response to detecting ice accumulation, the controller 26 may be configured to reduce the speed set point of the turbine 10, replace the normal pitch angle curve with an equivalent pitch angle curve representing the iced rotor blade 16, and/or update the optimal stall margin based on the equivalent pitch angle curve. In addition, the controller 26 may be configured to provide a pitch offset to the minimum pitch setting. In another embodiment, the controller 26 may also be configured to modify a torque constant of the torque-speed curve.

In additional embodiments, the controller 26 may also be configured to replace the optimal pitch curve by an equivalent curve describing the line corresponding iced blade. In further embodiments, the controller 26 may be configured to apply a worst case stall margin oven the non-iced minimum pitch curve instead of utilizing a completely new curve. In still another embodiment, the controller 26 may be configured to replace the aerodynamic maps affecting the turbine operation, i.e., thrust, torque and partial derivatives as well as the power coefficient map. Thus, the disclosed method 100 provides a simple and accurate method for mitigating ice throw of the wind turbine 10 while also maximizing power production.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for mitigating ice throw from one or more rotor blades of a wind turbine, the method comprising:
determining one or more ice-related parameters of the wind turbine, the one or more ice-related parameters being indicative of ice accumulation on one or more rotor blades of the wind turbine; and,
in response to detecting ice accumulation, implementing an ice protection control strategy, comprising:
determining a yaw position of the wind turbine, and
determining at least one of a power set point or a speed set point for the wind turbine based on the yaw position.

2. The method of claim 1, wherein determining at least one of the power set point or the speed set point for the wind turbine based on the yaw position further comprises:
determining at least one sector for the yaw position,
determining if the sector corresponds to one or more predetermined risk sectors, and
reducing at least one of the power set point or the speed set point of the wind turbine if the sector corresponds to one of the predetermined risk sectors.

3. The method of claim 2, further comprising at least one of maintaining the power set point and the speed set point of the wind turbine, reducing at least one of the power set point or the speed set point of the wind turbine, or increasing the power set point and the speed set point of the wind turbine if the sector does not correspond to one or more predetermined risk sectors.

4. The method of claim 1, wherein determining one or more ice-related parameters of the wind turbine further comprises monitoring one or more ice-related parameters via one or more sensors, the one or more sensors comprising at least one of accelerometers, internal icing sensors, external icing sensors, or vibration sensors.

5. The method of claim 1, wherein determining one or more ice-related parameters of the wind turbine further comprises calculating one or more ice-related parameters via at least one control algorithm.

6. The method of claim 1, wherein the ice-related parameters of the wind turbine further comprise at least one of or a combination of one or more ambient conditions near the wind turbine, a date, a time, a pitch angle of the one or more rotor blades, a tip-speed-ratio (TSR), a power output, a stall line, torque, thrust, or a power coefficient, wherein the one or more ambient conditions near the wind turbine comprise at least one of an ambient temperature, a component temperature, a pressure, wind speed, humidity, or an air density.

7. The method of claim 6, further comprising starting the ice protection control strategy when the ambient temperature is below a predetermined temperature set point and stopping the ice protection control strategy when the ambient temperature is above the predetermined temperature set point for a predetermined time period.

8. The method of claim 1, further comprising:
initially operating the wind turbine at an initial speed set point that corresponds to an optimal tip-speed-ratio value, an optimal pitch angle versus tip-speed-ratio (TSR) curve, and an optimal stall margin,
in response to detecting ice accumulation, replacing the optimal pitch angle versus TSR curve with an equivalent pitch angle curve representing the iced rotor blade, and
updating the optimal stall margin based on the equivalent pitch angle curve.

9. The method of claim 1, further comprising:
initially operating the wind turbine at an initial speed set point with a corresponding minimum pitch setting, and
in response to detecting ice accumulation, providing a pitch offset to the minimum pitch setting.

10. The method of claim 1, further comprising:
initially operating the wind turbine at a torque-speed curve, and
in response to detecting ice accumulation, modifying a torque constant of the torque-speed curve.

11. The method of claim 1, further comprising manually implementing the ice protection control strategy via a network.

12. A method for mitigating ice throw from one or more rotor blades of a wind turbine, the method comprising:
operating the wind turbine at an initial speed set point that corresponds to an optimal tip-speed-ratio value, an optimal pitch angle versus tip-speed-ratio (TSR) curve, and an optimal stall margin; and,
in response to detecting ice accumulation on the rotor blade, implementing an ice protection control strategy, wherein the ice protection control strategy comprises:
determining a yaw position of a rotor of the wind turbine,
determining an updated speed set point for the wind turbine based on the yaw position,
replacing the optimal pitch angle versus TSR curve with an equivalent pitch angle curve representing the iced rotor blade, and
updating the optimal stall margin based on the equivalent pitch angle curve.

13. A system for mitigating ice throw from one or more rotor blades of a wind turbine, the system comprising:
one or more sensors configured to monitor one or more ice-related parameters of the wind turbine, the ice-related parameters being indicative of ice accumulation on one or more rotor blades of the wind turbine; and,
a controller communicatively coupled to the one or more sensors, the controller configured to perform one or more operations, the one or more operations comprising:
implementing an ice protection control strategy in response to detecting ice accumulation, the ice protection strategy comprising:
determining a yaw position of the wind turbine, and
determining at least one of a power set point or a speed set point for the wind turbine based on the yaw position.

14. The system of claim 13, wherein determining at least one of the power set point or the speed set point for the wind turbine based on the yaw position further comprises:
determining at least one sector for the yaw position,
determining if the sector corresponds to one or more predetermined risk sectors, and
reducing at least one of the power set point or the speed set point of the wind turbine if the sector corresponds to one of the predetermined risk sectors.

15. The system of claim 13, further comprising at least one of maintaining the power set point and the speed set point of the wind turbine, reducing at least one of the power set point or the speed set point of the wind turbine, or increasing the power set point and the speed set point of the wind turbine if the sector does not correspond to one or more predetermined risk sectors.

16. The system of claim 13, wherein the one or more sensors comprise at least one of accelerometers, internal icing sensors, external icing sensors, or vibration sensors.

17. The system of claim 13, wherein the controller comprises a memory device comprising one or more control algorithms configured to calculate the one or more ice-related parameters.

18. The system of claim 13, wherein the ice-related parameters of the wind turbine further comprise at least one of or a combination of one or more ambient conditions near the wind turbine, a date, a time, a pitch angle of the one or more rotor blades, a tip-speed-ratio (TSR), a power output, a stall line, torque, thrust, or a power coefficient, wherein the one or more ambient conditions near the wind turbine comprise at least one of an ambient temperature, a component temperature, a pressure, wind speed, humidity, or an air density.

19. The system of claim 13, further comprising:
initially operating the wind turbine at an initial speed set point that corresponds to an optimal tip-speed-ratio value, an optimal pitch angle versus tip-speed-ratio (TSR) curve, and an optimal stall margin,
in response to detecting ice accumulation, replacing the optimal pitch angle versus TSR curve with an equivalent pitch angle curve representing the iced rotor blade, and updating the optimal stall margin based on the equivalent pitch angle curve.

20. The system of claim 13, further comprising a user interface communicatively coupled to the controller via a network, the user interface configured to allow a user to manually implement the ice protection control strategy.
